(19) United States
(12) Patent Application Publication
(10) Pub. No.: US 2014/0250035 A1
(43) Pub. Date: Sep. 4, 2014

(54) MODEL GENERATION DEVICE, PATTERN RECOGNITION APPARATUS AND METHODS THEREOF

(71) Applicant: CANON KABUSHIKI KAISHA, Tokyo (JP)

(72) Inventors: Haifeng Shen, Beijing (CN); Yuan Zhao, Beijing (CN); Xunqiang Tao, Beijing (CN); Hiroki Yamamoto, Yokohama-shi (JP)

(73) Assignee: CANON KABUSHIKI KAISHA, Tokyo (JP)

(21) Appl. No.: 14/191,296

(22) Filed: Feb. 26, 2014

(30) Foreign Application Priority Data
Mar. 1, 2013 (CN) 201310064923.9

(51) Int. Cl. G06N 99/00

(52) U.S. Cl. CPC G06N 99/005
USPC 706/12

(57) ABSTRACT

One aspect of the embodiments discloses a model generation device for pattern recognition, a pattern recognition apparatus and methods thereof. A mixture-level variance sharing step generates a mixture-level variance sharing structure of a first model by using a second model. A first model generation step generates the first model with the variance sharing structure by using training data of the first model, wherein in the variance sharing structure, mixture components in respective states have the same shared variances in the same order. The embodiment can at least provide better model parameter estimation so as to provide better recognition performance in the case of limited training data.

### BACKGROUND OF THE INVENTION

1. Field of the Invention

One disclosed aspect of the embodiments relates to the pattern recognition field, in particular relates to a model generation device for pattern recognition, a pattern recognition apparatus and methods thereof.

2. Description of the Related Art

Up to now, the pattern recognition technique has developed quickly, and has been widely used in gesture recognition, handwriting character recognition, speech recognition, speaker recognition etc.

In the pattern recognition field, the model generation method has an important effect on the needed memory size and the pattern recognition performance.

Common model generation methods do not have any variance sharing mechanism. FIG. 1 schematically shows such a method without variance sharing. Here, for purpose of simplicity, assuming that in addition to two virtual states, each model has two real states (a real state is a state having both transferring probability and outputting probability, and a virtual state is a state having only transferring probability without outputting probability). Besides, assuming that each real state has two mixture components, and each mixture component is, for example, a multi-dimensional Gaussian distribution. In the figure, the variance of each Gaussian distribution is shown in the form of a double-headed arrow underneath the Gaussian distribution, and the length of the double-headed arrow corresponds to the magnitude of the variance value. As shown in FIG. 1, in model 1, variances of mixture components of real state 1 are sequentially V1 and V2, and variances of mixture components of real state 2 are sequentially V3 and V4; and in model 2, variances of mixture components of real state 1 are sequentially V5 and V6, and variances of mixture components of real state 2 are sequentially V7 and V8. In the method without variance sharing as shown in FIG. 1, values of variances V1˜V8 may be different.

For the purpose of reducing the memory size or obtaining good model parameter estimation etc., variance sharing methods can be used during model generation.

US 2005/0192806A1 discloses a grand-fixed variance sharing method. According to this method, one global variance is obtained by averaging variances of a plurality of probability density functions. FIG. 2 schematically shows the grand-fixed variance sharing method.

As shown in FIG. 2, respective mixture components in respective real states of respective models have the same variance, i.e., V.

In addition, document ‘Discriminative Universal Background Model Training for Speaker Recognition’ by Wei-Qiang Zhang and Jia Liu (2011), Speech and Language Technologies, Prof. Ivo Ipsic (Ed.), ISBN: 978-953-307-322-4, InTech discloses a universal background model (UBM) variance sharing method. According to this method, the UBM is trained and variances in the UBM are shared for all target speaker models. FIG. 3 schematically shows the UBM variance sharing method. As shown in FIG. 3, states with the same state index in respective models share the same variances. More specifically, as for real state 1 of model 1 and real state 1 of model 2, variances of their mixture components are shared, i.e., variances of mixture components in real state 1 of model 1 are sequentially V1 and V2, and variances of mixture components in real state 1 of model 2 are sequentially V1 and V2, too. Moreover, as for real state 2 of model 1 and real state 2 of model 2, variances of their mixture components are shared, i.e., variances of mixture components in real state 2 of model 1 are sequentially V3 and V4, and variances of mixture components in real state 2 of model 2 are sequentially V3 and V4, too.

However, methods in the above documents have limits respectively.

In the grand-fixed variance sharing method disclosed in US 2005/0192806A1, since only one grand-fixed variance is used, the resolution for the variance is usually not so good. In view of this, compensation factors are used. However, the Gaussian probability computation process is frequently called during the decoding process, and additional multiplication or division operations to handle the compensation factors in this process take so much computation load. Moreover, an additional memory is needed for storing the compensation factors.

In addition, in the UBM variance sharing method disclosed by Wei-Qiang Zhang et.al., since all target models have the same state topology as the UBM, it is difficult to deal with cases where a target model has a different number of states or has a different number of mixture components per state. Moreover, in the case of limited training data, this method may not provide good model parameter estimation, because more variances need to be estimated.

Therefore, it is desired that a new model generation device for pattern recognition, a new pattern recognition apparatus and methods thereof can be provided.

### SUMMARY OF THE INVENTION

The disclosure is proposed in view of at least one of the above problems.

One object of the embodiments is to provide a new model generation device for pattern recognition, a new pattern recognition apparatus and methods thereof.

Another object of the embodiments is to provide a model generation device for pattern recognition, a pattern recognition apparatus and methods thereof which can at least suitably reduce the number of model parameters so as to suitably reduce the memory size.

Yet another object of the embodiments is to provide a model generation device for pattern recognition, a pattern recognition apparatus and methods thereof which can at least provide better model parameter estimation so as to provide better recognition performance in the case of limited training data.

According to a first aspect of the embodiments, there is provided a model generation method for pattern recognition, comprising the following steps: a mixture-level variance sharing step for generating a mixture-level variance sharing structure of a first model by using a second model; and a first model generation step for generating the first model with the variance sharing structure by using training data of the first model, wherein in the variance sharing structure, mixture components in respective states have the same shared variances in the same order.

According to a second aspect of the embodiments, there is provided a pattern recognition method, comprising the following steps: a feature extraction step for extracting features by using test data; and a pattern recognition step for performing pattern recognition on the extracted features by using the first model generated by the model generation method as described above.

According to a third aspect of the embodiments, there is provided a model generation device for pattern recognition, comprising the following units: a mixture-level variance sharing unit for generating a mixture-level variance sharing structure of a first model by using a second model; and a first model generation unit for generating the first model with the variance sharing structure by using training data of the first model, wherein in the variance sharing structure, mixture components in respective states have the same shared variances in the same order.

According to a fourth aspect of the embodiments, there is provided a pattern recognition apparatus, comprising the following devices: a feature extraction device for extracting features by using test data; and a pattern recognition device for performing pattern recognition on the extracted features by using the first model generated by the model generation device as described above.

By virtue of the above features, the model generation device for pattern recognition, the pattern recognition apparatus and methods thereof of the embodiments can at least suitably reduce the number of model parameters so as to suitably reduce the memory size.

In addition, by virtue of the above features, the model generation device for pattern recognition, the pattern recognition apparatus and methods thereof of the embodiments can also at least provide better model parameter estimation so as to provide better recognition performance in the case of limited training data.

Further objects, features and advantages of the disclosure will become apparent from the following detailed description of exemplary embodiments with reference to the attached drawings.

### BRIEF DESCRIPTION OF THE DRAWINGS

The accompanying drawings, which are incorporated in and constitute apart of the specification, illustrate embodiments of the disclosure and, together with the description, serve to explain the principles of the disclosure.

FIG. 1 is a schematic view of the method without variance sharing.

FIG. 2 is a schematic view of the grand-fixed variance sharing method.

FIG. 3 is a schematic view of the UBM variance sharing method.

FIG. 4 is a schematic view of a mixture-level variance sharing method.

FIG. 5 is a schematic block diagram of a hardware configuration of a computing device which can implement the model generation process and the pattern recognition process.

FIG. 6 is a schematic view of a seed model (i.e., a second model).

FIG. 7 schematically shows results after a variance sharing rule design step and a shared variance generation step of the model generation method.

FIG. 8 schematically shows a result after a mixture component reordering step of the model generation method.

FIG. 9 schematically shows a result after a shared variance copying rule design step of the model generation method.

FIG. 10 schematically shows a general flowchart of the model generation method.

FIG. 11 schematically shows a flowchart of a mixture-level variance sharing step of the model generation method.

FIGS. 12˜13 schematically show flowcharts of the variance sharing rule design step in the mixture-level variance sharing step of the model generation method.

FIGS. 14˜15 schematically show flowcharts for implementing the variance sharing rule design step in the mixture-level variance sharing step of the model generation method by using a constrained push-pop method.

FIG. 16 schematically shows a flowchart of the shared variance generation step in the mixture-level variance sharing step of the model generation method.

FIG. 17 schematically shows a flowchart of the shared variance copying rule design step in the mixture-level variance sharing step of the model generation method.

FIG. 18 schematically shows a general flowchart of the pattern recognition method.

FIG. 19 schematically shows a general block diagram of the model generation device.

FIG. 20 schematically shows a block diagram of a mixture-level variance sharing unit in the model generation device.

FIG. 21 schematically shows a general block diagram of the pattern recognition apparatus.

FIG. 22 is a schematic comparison diagram of different variance sharing methods in terms of recognition performance.

FIG. 23 is a schematic comparison diagram of different variance sharing methods in terms of the number of model parameters.

FIG. 24 is another schematic comparison diagram of different variance sharing methods in terms of recognition performance.

### DESCRIPTION OF THE EMBODIMENTS

Exemplary embodiments will be described in detail with reference to the drawings below. It shall be noted that the following description is merely illustrative and exemplary in nature, and is in no way intended to limit the disclosure and its applications or uses. The relative arrangement of components and steps, numerical expressions and numerical values set forth in the embodiments do not limit the scope of the disclosure unless it is otherwise specifically stated. In addition, techniques, methods and devices known by persons skilled in the art may not be discussed in detail, but are intended to be a part of the specification where appropriate.

The inventors find out after extensive and in-depth research that, compared to the above-mentioned method without variance sharing, the grand-fixed variance sharing method and the UBM variance sharing method, a new mixture-level variance sharing method can be employed to generate only a limited number of variances during model generation. FIG. 4 schematically shows the mixture-level variance sharing method. As shown in FIG. 4, in respective models, mixture components in respective states have the same shared variances in the same order. More specifically, as for each state of real states 1 and 2 of model 1 and real states 1 and 2 of model 2, variances of its mixture components are shared, i.e., variances of its mixture components are all sequentially V1 and V2. As will be seen from the following description, the mixture-level variance sharing method can suitably reduce the number of model parameters so as to suitably reduce the memory size. In addition, as will be seen from the following description, the mixture-level variance sharing method can also provide better model parameter estimation so as to provide better recognition performance in the case of limited training data.

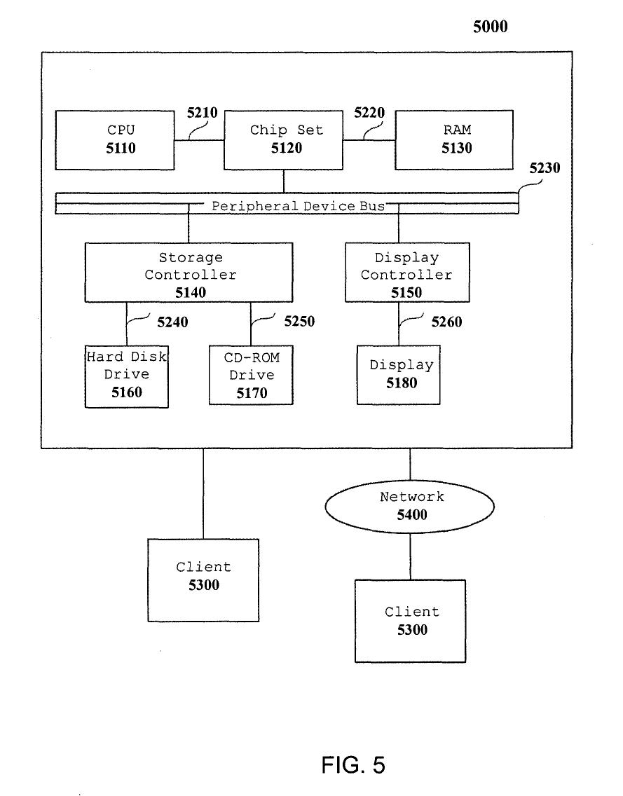

Below, first, a schematic hardware configuration of a computing device 5000 which can implement the model generation process and the pattern recognition process will be described with reference to FIG. 5. For the sake of simplicity, only one computing device is shown. However, a plurality of computing devices can also be used as needed.

As shown in FIG. 5, the computing device 5000 can comprise a CPU 5110, a chip set 5120, a RAM 5130, a storage controller 5140, a display controller 5150, a hard disk drive 5160, a CD-ROM drive 5170, and a display 5180. The computing device 5000 can also comprise a signal line 5210 that is connected between the CPU 5110 and the chip set 5120, a signal line 5220 that is connected between the chip set 5120 and the RAM 5130, a peripheral device bus 5230 that is connected between the chip set 5120 and various peripheral devices, a signal line 5240 that is connected between the storage controller 5140 and the hard disk drive 5160, a signal line 5250 that is connected between the storage controller 5140 and the CD-ROM drive 5170, and a signal line 5260 that is connected between the display controller 5150 and the display 5180.

A client 5300 can be connected to the computing device 5000 directly or via a network 5400. The client 5300 can send a model generation task and/or a pattern recognition task to the computing device 5000, and the computing device 5000 can return model generation results and/or pattern recognition results to the client 5300.

Next, the model generation method and the pattern recognition method will be described in detail. In the embodiments, a mixture-level variance sharing structure of a first model will be generated by using a second model, and then the first model with the variance sharing structure will be generated. Here, the second model can, for example, also be called a seed model, and the first model can, for example, also be called a target model.

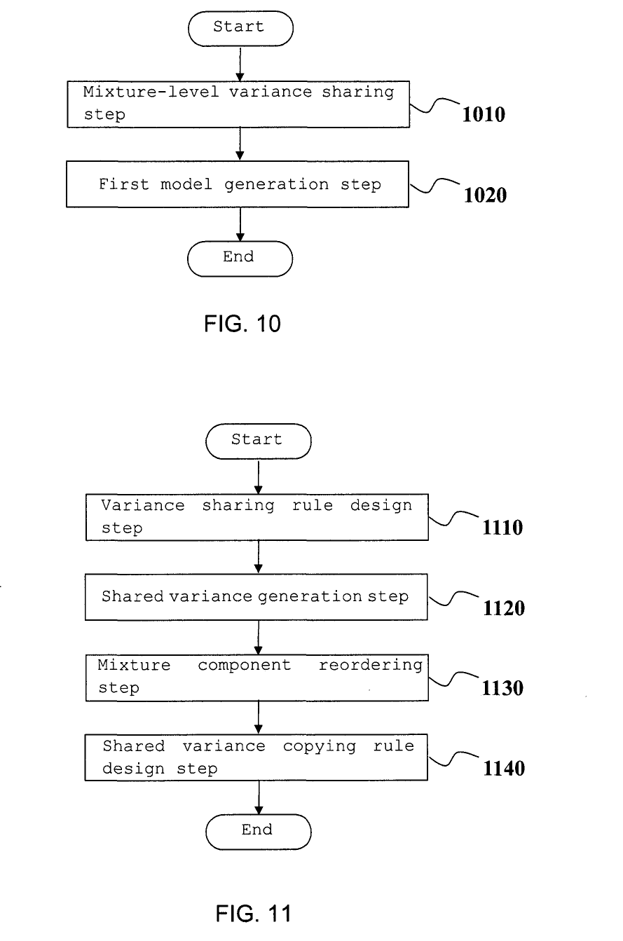

FIG. 10 schematically shows a general flowchart of the model generation method.

At step 1010 (the mixture-level variance sharing step), a mixture-level variance sharing structure of the first model is generated by using the second model. The mixture-level variance sharing structure comprises respective mixture-level shared variances.

Here, the second model is generated by using training data of the second model. The training data of the second model can use background data, the training data of the first model, both or the like. The second model can, for example, be at least one of a universal background model and a background model. The second model can, for example, be a Hidden Markov Model (HMM), a Gaussian Mixture Model (GMM) or the like. Here, description will be made with the HMM model and GMM model as an example. However, obviously, the model or model structure is not particularly limited as long as variances are used.

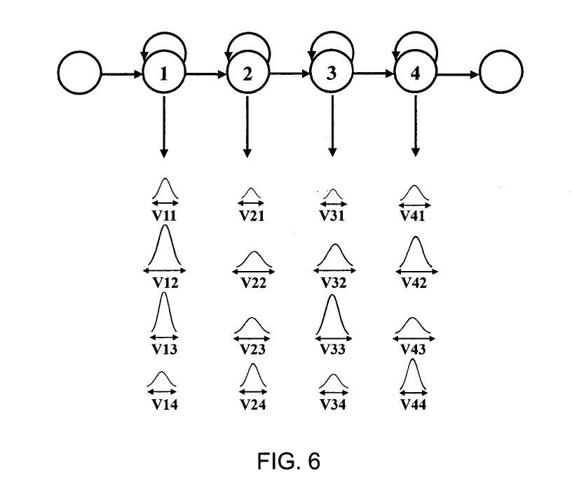

FIG. 6 shows a schematic view of the second model. Here, assuming that the model is a HMM model and has four real states in addition to two virtual states, and each real state is modelled as a GMM model having 4 mixture components. Of course, the number of states of the model and the number of mixture components of each state are not particularly limited. Although each mixture component has, in fact, parameters including constant item of Gaussian distribution, mixture weight, mean, variance and the like, only variances are shown in FIG. 6, since here attention is only paid to the variance item. More specifically, as shown in FIG. 6, variances of the 4 mixture components included in real state 1 are sequentially V11, V12, V13 and V14, variances of the 4 mixture components included in real state 2 are sequentially V21, V22, V23 and V24, variances of the 4 mixture components included in real state 3 are sequentially V31, V32, V33 and V34, and variances of the 4 mixture components included in real state 4 are sequentially V41, V42, V43 and V44 (i.e., in the index of variance V, the first number represents the state, and the second number represents the mixture component). Here, values of variances V11˜V44 may be different; there is no direct relationship among different states of the second model. Variances of the first model can be shared at the mixture-level by performing the mixture-level variance sharing step using the second model. More detailed description will be made on this later.

Then, at step 1020 (the first model generation step), the first model with the variance sharing structure is generated by using training data of the first model. In the variance sharing structure, mixture components in respective states have the same shared variances in the same order.

For example, variances of the first model can be initialized by using the variance sharing structure and the first model can be trained by using the training data of the first model so as to generate the first model. Meanwhile, the structure or topology and other model parameters of the first model can be initialized by using the second model or can be developed from scratch.

The model generation method can be conducted either on-line or off-line. Alternatively, according to actual requirement, one step of the model generation method can be conducted on-line, whereas another step thereof can be conducted off-line. This usually occurs in the case of on-line dictionary registration. For example, since the training data of the first model is collected on-line, the first model has to be generated on-line; but in this case, the second model can be generated off-line by using the training data of the second model, and the mixture-level variance sharing step can also be conducted off-line. In this way, when the device has only limited computation resource, computation load can be alleviated.

Moreover, training of the second model and training of the first model can be the same. Assuming that a HMM model is used to generate the first model and the second model. Traditional methods (e.g., Baum-Welch estimation with 5 iterations) can be used to update model parameters. Mixture components in each state are continuously split and the number of mixture components gradually increases until a target number of mixture components is reached.

Through the model generation method as described above, mixture-level variance sharing is achieved, which enables to suitably reduce the number of model parameters so as to suitably reduce the memory size, and which also enables to provide better model parameter estimation so as to provide better recognition performance.

The flowchart of FIG. 10 briefly shows basic steps of the model generation method. Hereinafter, more detailed description will be made on exemplary processes of the above respective steps.

FIG. 11 schematically shows a flowchart of the mixture-level variance sharing step of the model generation method.

As shown in FIG. 11, first, at step 1110 (the variance sharing rule design step), a variance sharing rule is designed by using the second model, wherein the variance sharing rule specifies mixture components to be sharing variances among respective states.

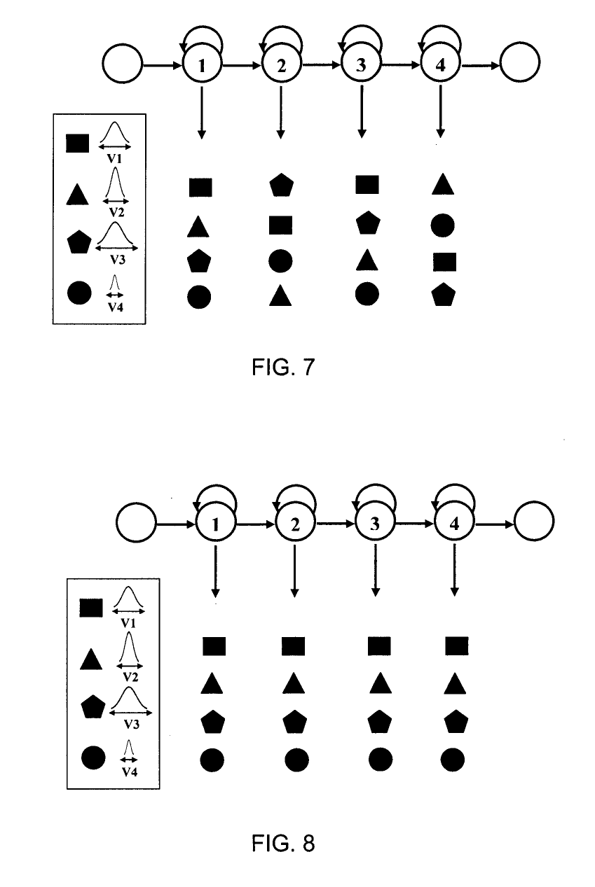

FIG. 7 schematically shows a result after the variance sharing rule design step. More specifically, the first mixture component of state 1, the second mixture component of state 2, the first mixture component of state 3 and the third mixture component of state 4 (denoted as rectangles in the figure) will share a variance, i.e., their variances will be the same; the second mixture component of state 1, the fourth mixture component of state 2, the third mixture component of state 3 and the first mixture component of state 4 (denoted as triangles in the figure) will share a variance, i.e., their variances will be the same; the third mixture component of state 1, the first mixture component of state 2, the second mixture component of state 3 and the fourth mixture component of state 4 (denoted as pentagons in the figure) will share a variance, i.e., their variances will be the same; and the fourth mixture component of state 1, the third mixture component of state 2, the fourth mixture component of state 3 and the second mixture component of state 4 (denoted as circles in the figure) will share a variance, i.e., their variances will be the same.

The easiest way is to design the variance sharing rule manually by a user based on prior knowledge. If no prior knowledge is available, the brute-force solution can be used to find the best variance sharing rule. However, this solution needs large computation load. In addition, the variance sharing rule can also be generated automatically by using various algorithms.

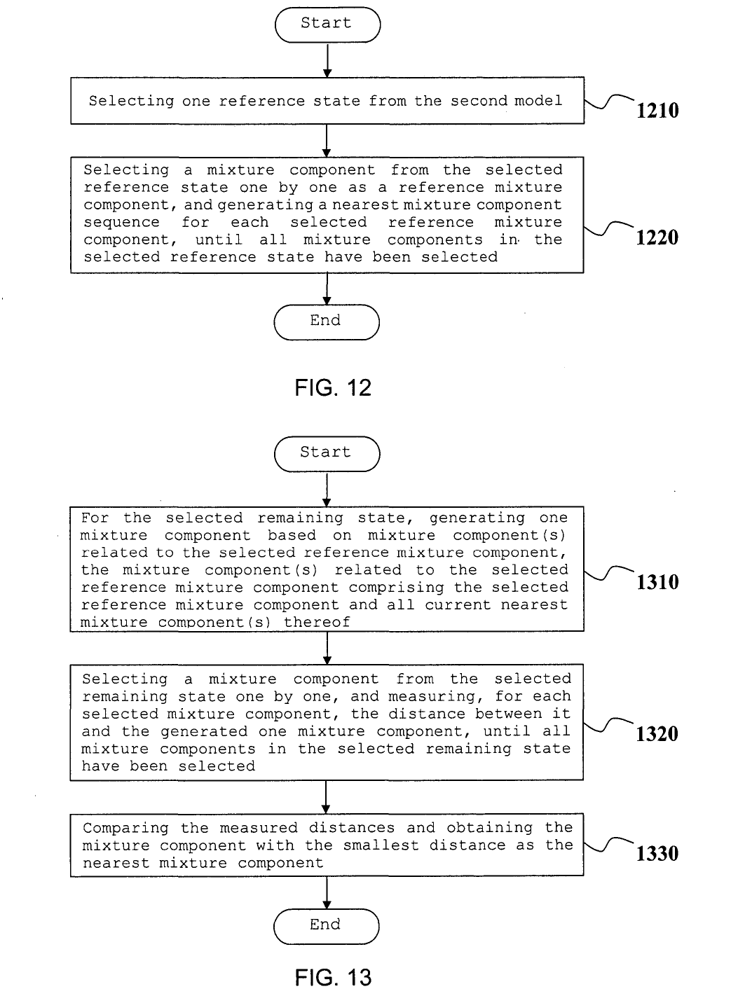

The variance sharing rule design step can, for example, be implemented through flowcharts shown in FIGS. 12˜13.

As shown in FIG. 12, first, at step 1210, one reference state is selected from the second model. Generally, the first real state having Gaussian probability density output can be selected as the reference state (e.g., state 1). However, the selection of the reference state is not necessarily limited thereto.

Then, at step 1220, a mixture component is selected from the selected reference state one by one as a reference mixture component, and a nearest mixture component sequence is generated for each selected reference mixture component, until all mixture components in the selected reference state have been selected.

Here, respective mixture components in each nearest mixture component sequence (i.e., mixture component sequences denoted respectively as rectangles, triangles, pentagons and circles in FIG. 7) are from respective states of the second model respectively, have the nearest distances among each others, and will have a shared variance. Moreover, the selecting order of mixture components is not particularly limited. Generally, the total number of the nearest mixture component sequences is equal to the total number of the mixture components in the reference state, and the total number of the mixture components in each nearest mixture component sequence is equal to the total number of the real states of the second model.

Further, the step of generating a nearest mixture component sequence for each selected reference mixture component can comprise the following step: for the selected reference mixture component, a remaining state is selected from remaining states of the second model other than the selected reference state (usually, in addition to the reference state, the second model has a plurality of states, e.g., states 2, 3 and 4) one by one, and one nearest mixture component is obtained for each selected remaining state, until all remaining states have been selected. Here, the selecting order of the remaining states is not particularly limited.

Still further, the step of obtaining one nearest mixture component for each selected remaining state can comprise the following steps as shown in FIG. 13.

First, at step 1310, for the selected remaining state, one mixture component is generated based on mixture component(s) related to the selected reference mixture component in step 1220. Here, the mixture component(s) related to the selected reference mixture component comprise(s) the selected reference mixture component and all current nearest mixture component(s) thereof. More detailed explanation will be made on this later. In addition, the one mixture component can, for example, be generated by using centroid(s) of the mixture component(s) related to the selected reference mixture component. However, obviously, the one mixture component can also be generated by using any other suitable method.

Then, at step 1320, a mixture component is selected from the selected remaining state one by one, and for each selected mixture component, the distance between it and the generated one mixture component in step 1310 is measured, until all mixture components in the selected remaining state have been selected. Here, the selecting order of the mixture components is not particularly limited. In addition, the distance can, for example, be at least one of a Bhattacharyya distance and a symmetric Kullback-Leibler distance (i.e., KL2 distance), or can be any other suitable distance. Moreover, the measurement of distance can, for example, use one of the following information: variance information; variance information and mean information; and variance information, mean information and mixture weight information.

Finally, at step 1330, the measured distances are compared and the mixture component with the smallest distance is obtained as the nearest mixture component.

Here, explanation will be made briefly on the phrase “the mixture component(s) related to the selected reference mixture component” in step 1310. As an example, in FIG. 6, assuming that state 1 is selected as the reference state, the first mixture component of state 1 (denoted as a rectangle in FIG. 7) is currently selected as the reference mixture component, and states 2˜4 are sequentially selected as the selected remaining state so as to obtain a nearest mixture component sequence comprising the selected reference mixture component (i.e., the first mixture component of state 1). First, when state 2 is selected as the selected remaining state, since no nearest mixture component of the selected reference mixture component has been obtained at this time, “the mixture component(s) related to the selected reference mixture component” in step 1310 is only the selected reference mixture component itself (i.e., the first mixture component of state 1 denoted as a rectangle). Next, when state 3 is selected as the selected remaining state, since one nearest mixture component of the selected reference mixture component (e.g., the second mixture component of state 2 denoted as a rectangle in FIG. 7) has been obtained at this time, “the mixture component(s) related to the selected reference mixture component” in step 1310 are the selected reference mixture component (i.e., the first mixture component of state 1 denoted as a rectangle) and the currently obtained one nearest mixture component (i.e., the second mixture component of state 2 denoted as a rectangle). Finally, when state 4 is selected as the selected remaining state, since two nearest mixture components of the selected reference mixture component (e.g., the second mixture component of state 2 denoted as a rectangle and the first mixture component of state 3 denoted as a rectangle in FIG. 7) have been obtained at this time, “the mixture component(s) related to the selected reference mixture component” in step 1310 are the selected reference mixture component (i.e., the first mixture component of state 1 denoted as a rectangle) and the currently obtained two nearest mixture components (i.e., the second mixture component of state 2 denoted as a rectangle and the first mixture component of state 3 denoted as a rectangle).

Through the above processing steps, the variance sharing rule can be obtained (e.g., as shown in FIG. 7).

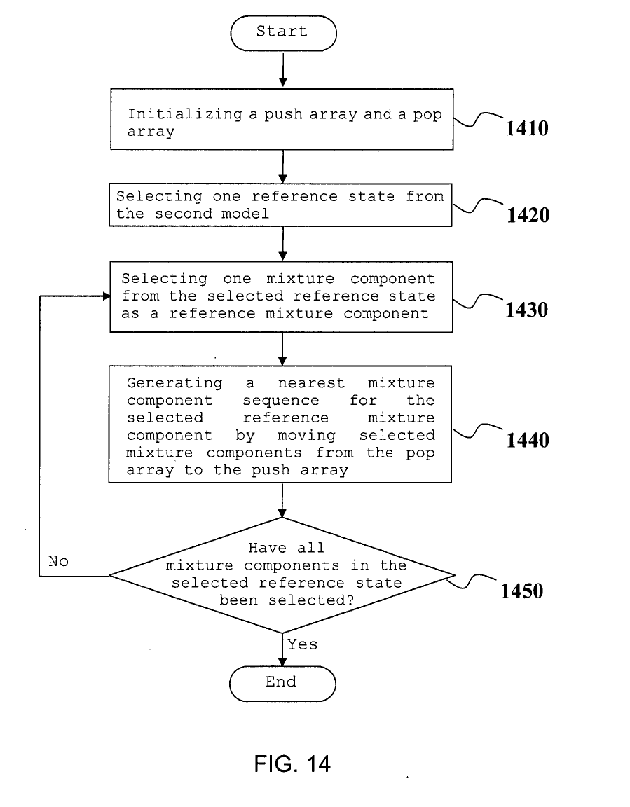

Below, as an example, description will be made on how to implement the variance sharing rule design step by specifically using a constrained push-pop method with reference to FIGS. 14˜15. The idea of the flowcharts in FIGS. 14˜15 is similar to that in FIGS. 12˜13, and the difference only lies in that the constrained push-pop method is specifically used in FIGS. 14˜15. Therefore, only a brief description will be made on FIGS. 14˜15 below, and the above description of FIGS. 12˜13 can be referred to for related contents.

As shown in FIG. 14, at step 1410, a push array and a pop array are initialized. Here, the push array and the pop array are used for recording selected mixture components and unselected mixture components in each state of the second model respectively. The initialized push array is empty, and all mixture components in all states of the second model are recorded in the initialized pop array.

At step 1420, one reference state is selected from the second model.

At step 1430, one mixture component is selected from the selected reference state as a reference mixture component.

At step 1440, a nearest mixture component sequence is generated for the selected reference mixture component by moving selected mixture components from the pop array to the push array.

Finally, at step 1450, it is judged whether all mixture components in the selected reference state have been selected. If Yes, the process ends; or else, the process returns to step 1430.

Further, the above step 1440 can comprise the following steps as shown in FIG. 15.

First, at step 1510, the selected reference mixture component in step 1430 is moved from the pop array to the push array.

Next, at step 1520, one remaining state is selected from remaining states of the second model other than the selected reference state.

At step 1530, one mixture component is generated based on mixture component(s) related to the selected reference mixture component in the push array.

Then, at step 1540, one mixture component in the selected remaining state is selected from the pop array.

At step 1550, the distance between the selected mixture component and the generated one mixture component is measured.

Next, at step 1560, it is judged whether all mixture components in the selected remaining state have been selected. If Yes, the process advances to step 1570; or else, the process returns to step 1540.

At step 1570, the measured distances are compared and the mixture component with the smallest distance is selected as the nearest mixture component.

Subsequently, at step 1580, the nearest mixture component is moved from the pop array to the push array.

Finally, at step 1590, it is judged whether all remaining states have been selected. If Yes, the process ends; or else, the process returns to step 1520.

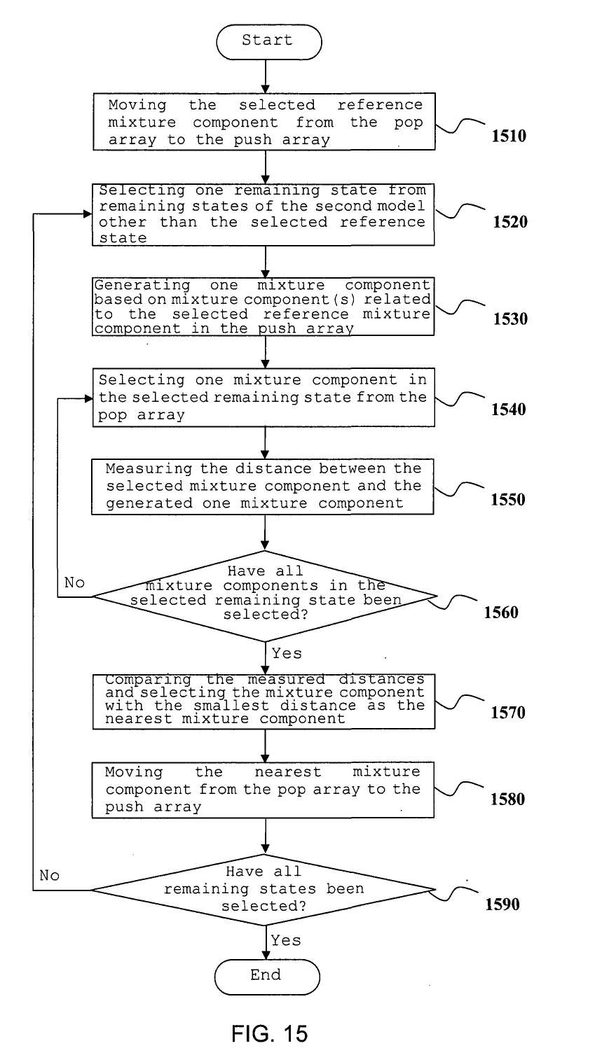

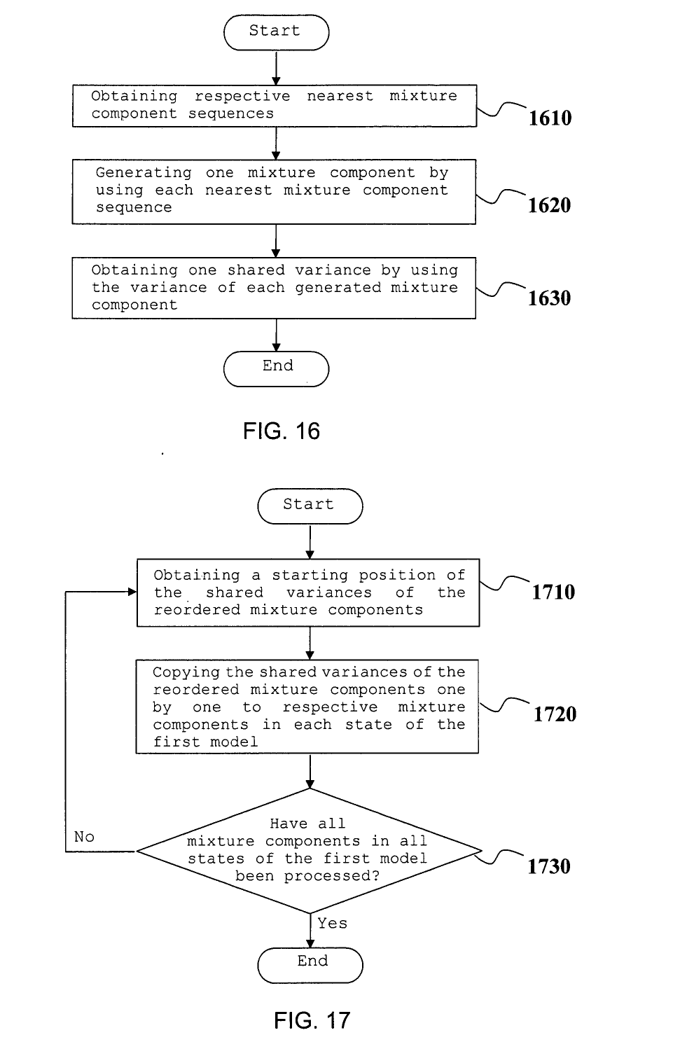

Now returning to FIG. 11. After the variance sharing rule design step 1110, a shared variance generation step 1120 is performed for generating shared variances (i.e., estimating values of respective shared variances) based on the variance sharing rule. FIG. 16 schematically shows a flowchart of the shared variance generation step.

As shown in FIG. 16, at step 1610, respective nearest mixture component sequences are obtained. For example, in the case of using the constrained push-pop method, the respective nearest mixture component sequences can be obtained from the push array.

Next, at step 1620, one mixture component is generated by using each nearest mixture component sequence. Step 1620 can be performed by using any suitable method. For example, the one mixture component can be generated by merging respective mixture components in each nearest mixture component sequence. This can, for example, be achieved by creating the centroid of the nearest mixture component sequence. Alternatively, the one mixture component can be generated by obtaining a representative mixture component in each nearest mixture component sequence. In addition, step 1620 can use one of the following information: variance information of the nearest mixture component sequence; variance information and mean information of the nearest mixture component sequence; and variance information, mean information and mixture weight information of the nearest mixture component sequence. The disclosure is not particularly limited thereto.

Finally, at step 1630, one shared variance is obtained by using the variance of each generated mixture component. In other words, the variance of each generated mixture component is obtained as one shared variance.

FIG. 7 schematically shows a result after the shared variance generation step in the box on its left. More specifically, variances of respective mixture components in the nearest mixture component sequence denoted as rectangles in the figure are all V1, variances of respective mixture components in the nearest mixture component sequence denoted as triangles in the figure are all V2, variances of respective mixture components in the nearest mixture component sequence denoted as pentagons in the figure are all V3, and variances of respective mixture components in the nearest mixture component sequence denoted as circles in the figure are all V4. The shared variance generation step specifically calculates values of respective shared variances V1˜V4. Up to now, mixture components in respective states of the second model have the same variances; in other words, all states of the second model use the same variances. In the example shown in FIG. 7, all states of the second model use the same four shared variances V1˜V4, but the order of the shared variances V1˜V4 is usually different.

Returning to FIG. 11 again. After the shared variance generation step 1120, a mixture component reordering step 1130 is performed for reordering mixture components in each state of the second model based on the generated shared variances so that the shared variances of the mixture components in respective states of the second model are in the same order.

For example, the mixture component reordering step 1130 can reorder the mixture components in each state of the second model based on the order of the generated shared variances.

FIG. 8 schematically shows a result after the mixture component reordering step. As shown in FIG. 8, mixture components in respective states of the second model use the same shared variances, and the order of the shared variances is the same. In other words, in respective states of the second model, mixture components with the same index use the same shared variance. More specifically, after the mixture component reordering step, the first mixture components of states 1˜4 all use the shared variance V1 (all of them are denoted as rectangles), the second mixture components of states 1˜4 all use the shared variance V2 (all of them are denoted as triangles), the third mixture components of states 1˜4 all use the shared variance V3 (all of them are denoted as pentagons), and the fourth mixture components of states 1˜4 all use the shared variance V4 (all of them are denoted as circles). They are in the same order as the shared variances shown in the left box of FIG. 8.

It is to be noted that, although not mentioned in the specification, an ordering process may have already been performed with respect to variances of the mixture components previously (e.g., in a previous training stage), therefore step 1130 is called the mixture component reordering step here. In addition, it is to be noted that, as described above, each mixture component has parameters including constant item of Gaussian distribution, mixture weight, mean, variance and the like. Although the mixture component reordering step 1130 performs the reordering with respect to variances of the mixture components, the above described various parameters shall be reordered together during the reordering.

Returning to FIG. 11 again. After the mixture component reordering step 1130, a shared variance copying rule design step 1140 is performed for designing a shared variance copying rule to generate the variance sharing structure of the first model by using the shared variances of the reordered mixture components.

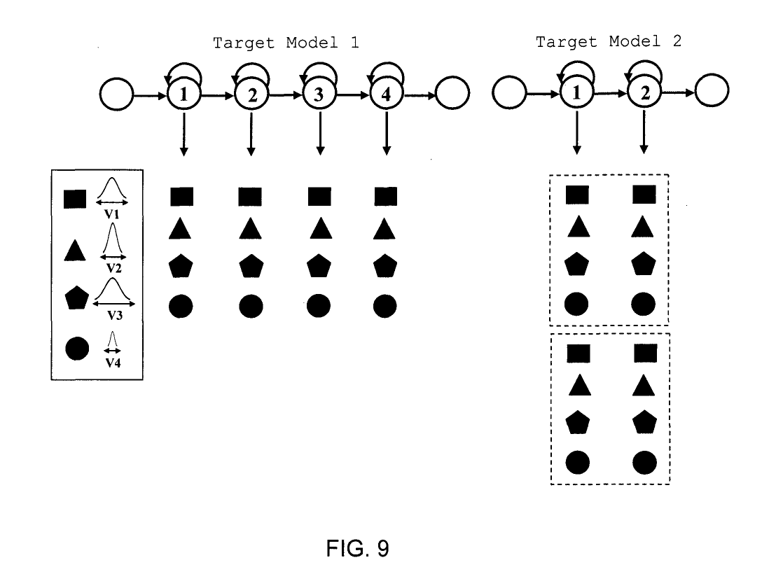

FIG. 9 schematically shows a result after the shared variance copying rule design step. FIG. 9 shows variance sharing structures of two kinds of the first models (i.e., two kinds of target models). As shown in FIG. 9, target model 1 and target model 2 have different numbers of states and different numbers of mixture components per state. This usually occurs in applications where there exist a background model and several foreground models. Generally, the number of states in the background model is less than those in the foreground models, and the number of mixture components per state in the background model is greater than those in the foreground models. Since each state of the second model has the same shared variances in same order after the mixture component reordering step, when copying the shared variances from the second model to the first model, it is not necessary to particularly care about whether the first model has the same number of states as the second model, and it is only necessary to care about whether the numbers of mixture components per state of the first and second models are the same. In the case that the first model has a different number of mixture components per state compared to the second model, different shared variance copying rules have to be designed for different models. In the example shown in FIG. 9, compared to the second model, target model 1 has the same number of mixture components per state, but target model 2 has double number of mixture components per state (i.e., each state has 8 mixture components). As to target model 2, for example, additional ordered shared variances V1˜V4 can be copied for the last 4 mixture components of each state.

In addition, compared to the second model, the number of mixture components per state of the first model (i.e., the target model) may be less or may not have a multiple relation to the number of mixture components per state of the second model sometimes. In such cases, the shared variance copying rule design step can, for example, be performed through the following process. First, a starting position (e.g., V1) of the shared variances of the reordered mixture components can be obtained. Then, the shared variances of the reordered mixture components can be repeatedly copied one by one to respective mixture components in each state of the first model, until all mixture components in each state of the first model have copied shared variances. In such a way, the shared variance copying rule design step becomes feasible and flexible. In particular, compared to the above-mentioned UBM variance sharing method, the mixture-level variance sharing method is easy to deal with cases where the target model has a different number of states or has a different number of mixture components per state.

FIG. 17 shows a schematic flowchart of the shared variance copying rule design step.

As shown in FIG. 17, first, at step 1710, a starting position of the shared variances of the reordered mixture components is obtained.

Then, at step 1720, the shared variances of the reordered mixture components are copied one by one to respective mixture components in each state of the first model.

Subsequently, at step 1730, it is judged whether all mixture components in all states of the first model have been processed. If Yes, the process ends; or else, the process returns to step 1710.

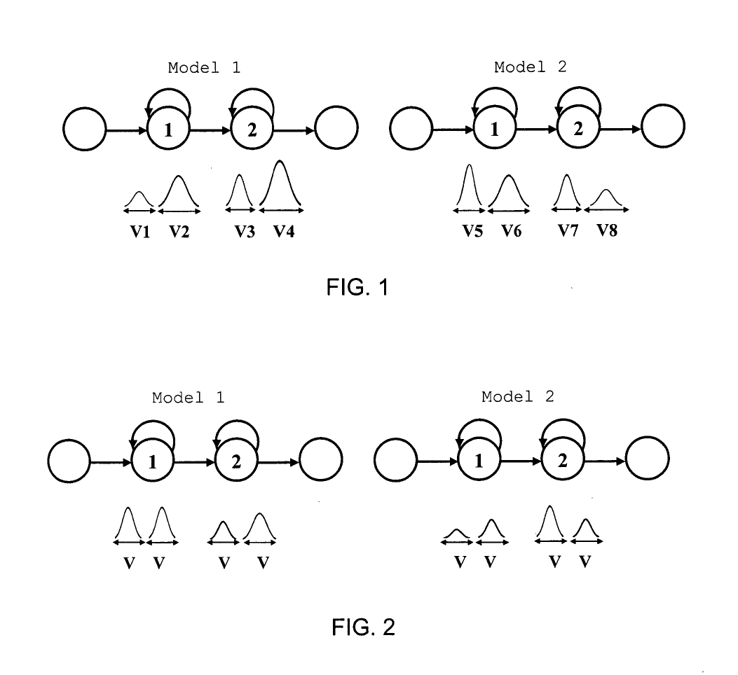

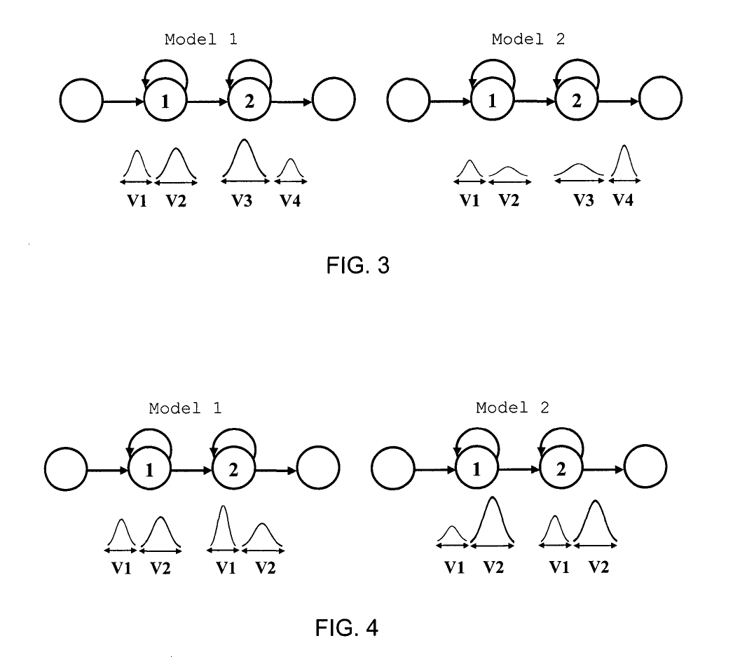

Up to now, the model generation method has been schematically described. Compared to the method without variance sharing, the grand-fixed variance sharing method and the UBM variance sharing method as described above (referring to FIGS. 1˜3), the mixture-level variance sharing method (referring to FIG. 4) generates a suitable number of variances during model generation. As will be seen from the following evaluation results, the mixture-level variance sharing method can suitably reduce the number of model parameters by suitably reduce the number of variances so as to suitably reduce the memory size. In addition, the mixture-level variance sharing method can also provide better model parameter estimation so as to provide better recognition performance in the case of limited training data. Also, compared to the grand-fixed variance sharing method, the mixture-level variance sharing method only needs smaller memory size and less computation load since no compensation factor is needed; and compared to the UBM variance sharing method, the mixture-level variance sharing method only needs smaller memory size to store less variances, and can also provide better model parameter estimation in the case of limited training data.

Incidentally, the embodiments can be implemented either in a vector way or in a scalar way.

Now, effects of the model generation method will be evaluated. Incidentally, here, the method without variance sharing, the grand-fixed variance sharing method, the UBM variance sharing method and the mixture-level variance sharing method can represent a model generation method without variance sharing, a model generation method using grand-fixed variance sharing, a model generation method using UBM variance sharing and a model generation method using mixture-level variance sharing, respectively.

The experiments employ 8 persons' gesture data for model generation and 6 persons' gesture data for model evaluation. The vocabulary comprises 10 gesture words.

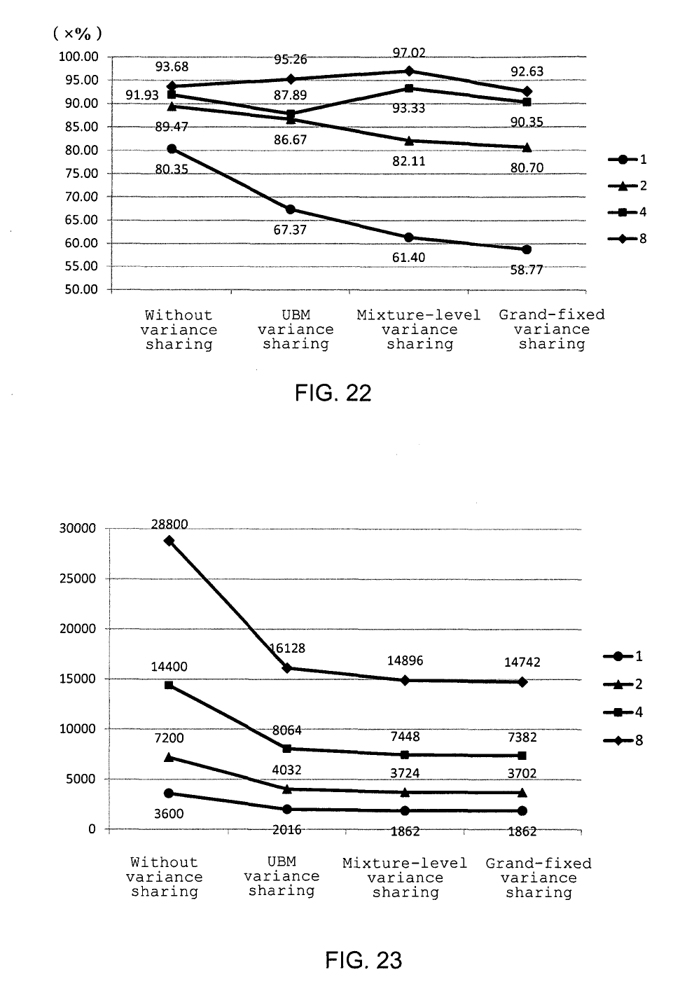

The first experiment is used to validate the effectiveness of the mixture-level variance sharing method over other methods in the case of limited training data in terms of both the recognition performance and the number of model parameters. Here, all methods use the same seed model based generation procedure, and the difference only lies in that different variance sharing mechanisms are used. FIG. 22 shows a schematic comparison diagram of various methods in terms of the recognition performance, and FIG. 23 shows a schematic comparison diagram of various methods in terms of the number of model parameters. In FIGS. 22˜23, evaluation is performed on cases with different numbers of mixture components per state (i.e., 1, 2, 4 and 8).

As shown in FIG. 22, in the case where each state has 1 mixture component, the method without variance sharing achieves the best recognition performance (80.35%). However, this recognition performance is still bad compared to cases where each state has more mixture components. As the number of mixture components per state increases, the recognition performance of the mixture-level variance sharing method improves continuously and improves more greatly than those of other methods. More specifically, the recognition performance of the mixture-level variance sharing method outperforms those of other methods in the case where each state has 4 mixture components, and arrives at the best value (97.02%) in the case where each state has 8 mixture components. One reason why the recognition performance of the mixture-level variance sharing method is better than those of other methods is that, the method can provide a suitable number of model parameters, thereby it is easy to obtain better model parameter evaluation. This is readily apparent from FIG. 23. In FIG. 23, compared to the model size of the method without variance sharing, the model size of the mixture-level variance sharing method is nearly half.

Incidentally, in FIG. 22, in the case where each state has 1 mixture component, the recognition performance of the mixture-level variance sharing method is different from that of the grand-fixed variance sharing method. The reason lies in that, the grand-fixed variance sharing method uses one variance at the outset during initialization, which is estimated from the training data and updated during iteration; in comparison thereto, the mixture-level variance sharing method computes one variance after the mixture-level variance sharing step is finished, but before the computation, variance values in respective states may be different. That is to say, processing procedures of these two methods are slightly different.

As can be seen from the above, the model generation method with mixture-level variance sharing mechanism can suitably reduce the number of model parameters by suitably reduce the number of variances, thereby can suitably reduce the memory size.

Also, as can be seen from the above, in the case of limited training data, the model generation method with mixture-level variance sharing mechanism can also provide better model parameter estimation, thereby can provide better recognition performance.

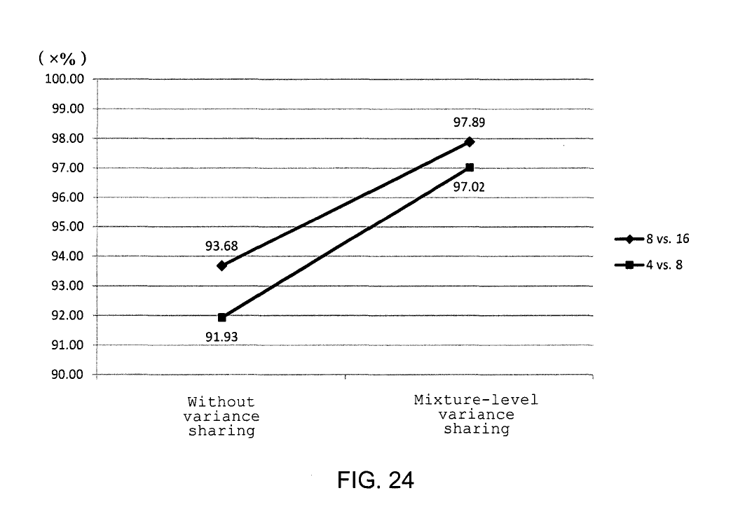

The second experiment is used to compare recognition performances of the method without variance sharing and the mixture-level variance sharing method under the condition of nearly the same model size. FIG. 24 shows the comparison results. In FIG. 24, comparison is carried out for two cases. The first case is that, each state has 8 mixture components for the method without variance sharing, while each state has 16 mixture components for the mixture-level variance sharing method (i.e., 8 vs. 16 in the figure). The second case is that, each state has 4 mixture components for the method without variance sharing, while each state has 8 mixture components for the mixture-level variance sharing method (i.e., 4 vs. 8 in the figure). In each case, the total numbers of model parameters of the two methods are similar considering that the Gaussian distribution of each mixture component comprises model parameters of variance, mean and the like. As shown in FIG. 24, under the condition of similar total numbers of model parameters, the recognition performance of the mixture-level variance sharing method outperforms that of the method without variance sharing by 4.21% and 5.09%, respectively. That is to say, for each case in FIG. 24, when the number of mixture components per state is increased (changing from 8 to 16 or from 4 to 8) so as to increase the number of variances and the number of means, the total number of model parameters still remains similar since the mixture-level variance sharing mechanism is employed to weaken the variances to some extent without changing the means, besides, the recognition performance is improved to some extent. This proves that mean parameters contribute much to the recognition performance than variance parameters. Therefore, the number of mean parameters can be relaxed relatively by reducing the number of variance parameters.

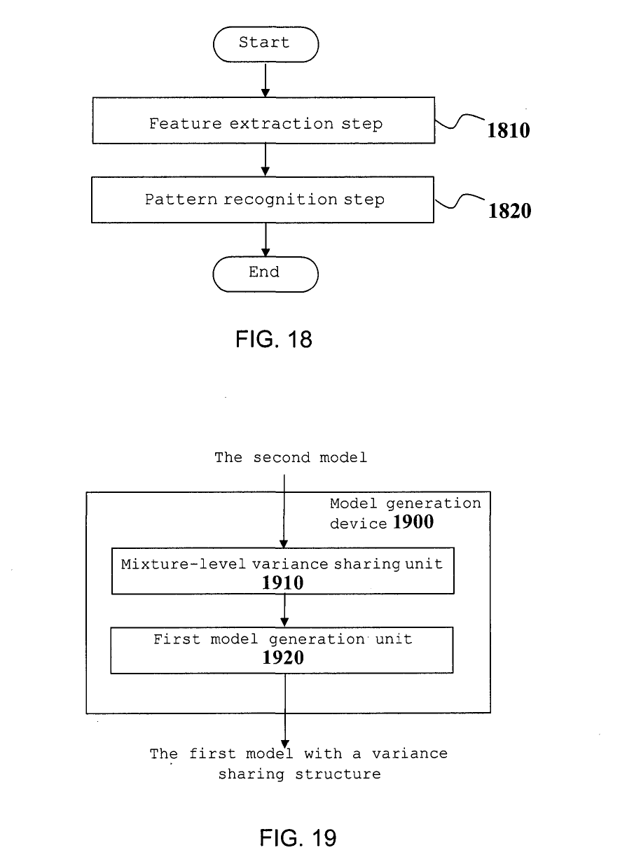

The disclosure can be applied to various kinds of pattern recognition, such as gesture recognition, handwriting character recognition, speech recognition, speaker recognition and the like. Next, a schematic procedure of the pattern recognition method will be briefly described with reference to FIG. 18.

FIG. 18 schematically shows a general flowchart of the pattern recognition method.

As shown in FIG. 18, at step 1810 (the feature extraction step), features are extracted by using test data. For example, in gesture recognition or handwriting character recognition, position features such as coordinates, direction features such as slopes and the like can generally be used; and in speech recognition or speaker recognition, Mel Frequency Cepstrum Coefficient (MFCC), Perceptual Linear Prediction Coefficient (PLPC) and the like can generally be used.

Then, at step 1820 (the pattern recognition step), pattern recognition is performed on the extracted features by using the first model generated by the model generation method.

Up to now, the pattern recognition method has been described schematically. Hereinafter, a model generation device and a pattern recognition apparatus will be described briefly with reference to FIGS. 19˜21.

FIG. 19 schematically shows a general block diagram of the model generation device. As shown in FIG. 19, the model generation device 1900 for pattern recognition can comprises the following units: a mixture-level variance sharing unit 1910 for generating a mixture-level variance sharing structure of a first model by using a second model; and a first model generation unit 1920 for generating the first model with the variance sharing structure by using training data of the first model, wherein in the variance sharing structure, mixture components in respective states have the same shared variances in the same order.

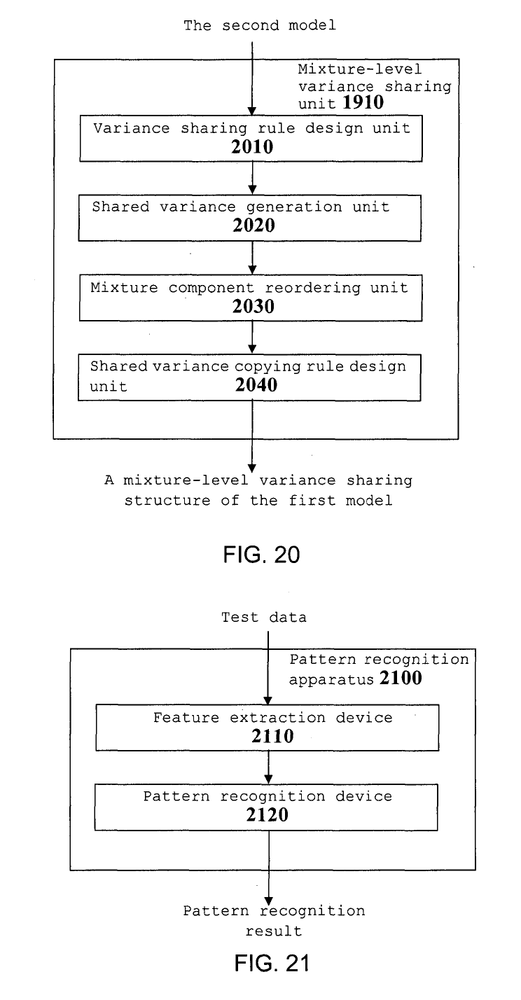

FIG. 20 schematically shows a block diagram of the mixture-level variance sharing unit in the model generation device. In some embodiments, as shown in FIG. 20, the mixture-level variance sharing unit 1910 can further comprise the following units: a variance sharing rule design unit 2010 for designing a variance sharing rule by using the second model, the variance sharing rule specifying mixture components to be sharing variances among respective states; a shared variance generation unit 2020 for generating shared variances based on the variance sharing rule; a mixture component reordering unit 2030 for reordering mixture components in each state of the second model based on the generated shared variances so that the shared variances of the mixture components in respective states of the second model are in the same order; and a shared variance copying rule design unit 2040 for designing a shared variance copying rule to generate the variance sharing structure by using the shared variances of the reordered mixture components.

In some embodiments, the variance sharing rule design unit can further comprise the following units: a unit for selecting one reference state from the second model; and a unit for selecting a mixture component from the selected reference state one by one as a reference mixture component, and generating a nearest mixture component sequence for each selected reference mixture component, until all mixture components in the selected reference state have been selected, wherein respective mixture components in each nearest mixture component sequence are from respective states of the second model respectively, have the nearest distances among each others, and will have a shared variance.

In some embodiments, the unit of generating a nearest mixture component sequence for each selected reference mixture component can further comprise the following unit: for the selected reference mixture component, a unit for selecting, from remaining states of the second model other than the selected reference state, a remaining state one by one, and obtaining one nearest mixture component for each selected remaining state, until all remaining states have been selected.

In some embodiments, the unit of obtaining one nearest mixture component for each selected remaining state can further comprise the following units: a unit for generating, for the selected remaining state, one mixture component based on mixture component(s) related to the selected reference mixture component, the mixture component(s) related to the selected reference mixture component comprising the selected reference mixture component and all current nearest mixture component(s) thereof; a unit for selecting a mixture component from the selected remaining state one by one, and measuring, for each selected mixture component, the distance between it and the generated one mixture component, until all mixture components in the selected remaining state have been selected; and a unit for comparing the measured distances and obtaining the mixture component with the smallest distance as the nearest mixture component.

In some embodiments, the variance sharing rule design unit can employ a constrained push-pop method; the variance sharing rule design unit can further comprise a unit for initializing a push array and a pop array before selecting one reference state from the second model, the push array and the pop array being used for recording selected mixture components and unselected mixture components in each state of the second model respectively, the initialized push array being empty, and all mixture components in all states of the second model being recorded in the initialized pop array; the unit of generating a nearest mixture component sequence for each selected reference mixture component can further comprise a unit for moving the selected reference mixture component from the pop array to the push array before selecting, from remaining states of the second model other than the selected reference state, a remaining state one by one; and the unit of generating a nearest mixture component sequence for each selected reference mixture component can further comprise a unit for moving the obtained one nearest mixture component from the pop array to the push array after obtaining the one nearest mixture component for each selected remaining state.

In some embodiments, the shared variance generation unit can further comprise the following units: a unit for obtaining respective nearest mixture component sequences; a unit for generating one mixture component by using each nearest mixture component sequence; and a unit for obtaining one shared variance by using the variance of each generated mixture component.

In some embodiments, the unit of generating one mixture component by using each nearest mixture component sequence can further comprise the following unit: a unit for generating the one mixture component by merging respective mixture components in each nearest mixture component sequence; or a unit for generating the one mixture component by obtaining a representative mixture component in each nearest mixture component sequence.

In some embodiments, the mixture component reordering unit can reorder the mixture components in each state of the second model based on the order of the generated shared variances.

In some embodiments, the shared variance copying rule design unit can further comprise the following units: a unit for obtaining a starting position of the shared variances of the reordered mixture components; and a unit for repeatedly copying the shared variances of the reordered mixture components one by one to respective mixture components in each state of the first model, until all mixture components in each state of the first model have copied shared variances.

In some embodiments, the second model can be generated off-line by using training data of the second model; the mixture-level variance sharing unit can generate the mixture-level variance sharing structure of the first model off-line; and the first model generation unit can generate the first model with the variance sharing structure on-line.

In some embodiments, the second model can be at least one of a universal background model and a background model.

In some embodiments, the second model can be a Hidden Markov Model or a Gaussian Mixture Model.

In some embodiments, the distance is at least one of a Bhattacharyya distance and a symmetric Kullback-Leibler distance.

In some embodiments, the unit of generating one mixture component by using each nearest mixture component sequence can use one of the following information: variance information of the nearest mixture component sequence; variance information and mean information of the nearest mixture component sequence; and variance information, mean information and mixture weight information of the nearest mixture component sequence.

In addition, FIG. 21 schematically shows a general block diagram of the pattern recognition apparatus. As shown in FIG. 21, the pattern recognition apparatus 2100 can comprise the following devices: a feature extraction device 2110 for extracting features by using test data; and a pattern recognition device 2120 for performing pattern recognition on the extracted features by using the first model generated by the model generation device.

Up to now, the model generation device and the pattern recognition apparatus have been described schematically. It shall be noted that, all the above devices and apparatuses are exemplary preferable modules for implementing the model generation method and the pattern recognition method. However, modules for implementing the various steps are not described exhaustively above. Generally, where there is a step of performing a certain process, there is a corresponding functional module or means for implementing the same process. In addition, it shall be noted that, two or more means can be combined as one means as long as their functions can be achieved; on the other hand, any one means can be divided into a plurality of means, as long as similar functions can be achieved.

It is possible to implement the methods, devices and apparatuses in many ways. For example, it is possible to implement the methods, devices and apparatuses through software, hardware, firmware or any combination thereof. The above described order of the steps for the methods is only intended to be illustrative, and the steps of the methods are not necessarily limited to the above specifically described order unless otherwise specifically stated. Besides, in some embodiments, the disclosure can also be embodied as programs recorded in a recording medium, including machine-readable instructions for implementing the methods. Thus, the disclosure also covers recording mediums which store the programs for implementing the methods.

While the disclosure has been described with reference to exemplary embodiments, it is to be understood that the disclosure is not limited to the disclosed exemplary embodiments. It is apparent to those skilled in the art that the above exemplary embodiments may be modified without departing from the scope and spirit of the disclosure. The scope of the following claims is to be accorded the broadest interpretation so as to encompass all such modifications and equivalent structures and functions.

This application claims priority from Chinese Patent Application No. 201310064923.9 filed Mar. 1, 2013, which is hereby incorporated by reference herein in its entirety.

What is claimed is:

1. A model generation method for pattern recognition, comprising:
a mixture-level variance sharing step for generating a mixture-level variance sharing structure of a first model by using a second model; and
a first model generation step for generating the first model with the variance sharing structure by using training data of the first model,
wherein in the variance sharing structure, mixture components in respective states have the same shared variances in the same order.

2. The model generation method according to claim 1, wherein the mixture-level variance sharing step further comprises the following steps:
a variance sharing rule design step for designing a variance sharing rule by using the second model, the variance sharing rule specifying mixture components to be sharing variances among respective states;
a shared variance generation step for generating shared variances based on the variance sharing rule;
a mixture component reordering step for reordering mixture components in each state of the second model based on the generated shared variances so that the shared variances of the mixture components in respective states of the second model are in the same order; and
a shared variance copying rule design step for designing a shared variance copying rule to generate the variance sharing structure by using the shared variances of the reordered mixture components.

3. The model generation method according to claim 2, wherein the variance sharing rule design step further comprises the following steps:
selecting one reference state from the second model; and
selecting a mixture component from the selected reference state one by one as a reference mixture component, and generating a nearest mixture component sequence for each selected reference mixture component, until all mixture components in the selected reference state have been selected,
wherein respective mixture components in each nearest mixture component sequence are from respective states of the second model respectively, have the nearest distances among each others, and will have a shared variance.

4. The model generation method according to claim 3, wherein the step of generating a nearest mixture component sequence for each selected reference mixture component further comprises the following step:
for the selected reference mixture component, selecting, from remaining states of the second model other than the selected reference state, a remaining state one by one, and obtaining one nearest mixture component for each selected remaining state, until all remaining states have been selected.

5. The model generation method according to claim 4, wherein the step of obtaining one nearest mixture component for each selected remaining state further comprises the following steps:
for the selected remaining state, generating one mixture component based on at least a mixture component related to the selected reference mixture component, the at least mixture component related to the selected reference mixture component comprising the selected reference mixture component and all current nearest mixture components thereof;
selecting a mixture component from the selected remaining state one by one, and measuring, for each selected mixture component, the distance between it and the generated one mixture component, until all mixture components in the selected remaining state have been selected; and
comparing the measured distances and obtaining the mixture component with the smallest distance as the nearest mixture component.

6. The model generation method according to claim 4, wherein the variance sharing rule design step employs a constrained push-pop method,
the variance sharing rule design step further comprises, before the step of selecting one reference state from the second model, the following step: initializing a push array and a pop array, the push array and the pop array being used for recording selected mixture components and unselected mixture components in each state of the second model respectively, the initialized push array being empty, and all mixture components in all states of the second model being recorded in the initialized pop array;
the step of generating a nearest mixture component sequence for each selected reference mixture component further comprises, before the step of selecting, from remaining states of the second model other than the selected reference state, a remaining state one by one, the following step: moving the selected reference mixture component from the pop array to the push array; and
the step of generating a nearest mixture component sequence for each selected reference mixture component further comprises, after the step of obtaining the one nearest mixture component for each selected remaining state, the following step: moving the obtained one nearest mixture component from the pop array to the push array.

7. The model generation method according to claim 3, wherein the shared variance generation step further comprises:
obtaining respective nearest mixture component sequences;
generating one mixture component by using each nearest mixture component sequence; and
obtaining one shared variance by using the variance of each generated mixture component.

8. The model generation method according to claim 7, wherein the step of generating one mixture component by using each nearest mixture component sequence further comprises:
generating the one mixture component by merging respective mixture components in each nearest mixture component sequence; or
generating the one mixture component by obtaining a representative mixture component in each nearest mixture component sequence.

9. The model generation method according to claim 2, wherein the mixture component reordering step reorders the mixture components in each state of the second model based on the order of the generated shared variances.

10. The model generation method according to claim 2, wherein the shared variance copying rule design step further comprises:
obtaining a starting position of the shared variances of the reordered mixture components; and
repeatedly copying the shared variances of the reordered mixture components one by one to respective mixture components in each state of the first model, until all mixture components in each state of the first model have copied shared variances.

11. The model generation method according to claim 1,
wherein the second model is generated off-line by using training data of the second model;
the mixture-level variance sharing step is performed off-line; and
the first model generation step is performed on-line.

12. The model generation method according to claim 1, wherein the second model is at least one of a universal background model and a background model.

13. The model generation method according to claim 12, wherein the second model is a Hidden Markov Model or a Gaussian Mixture Model.

14. The model generation method according to claim 3, wherein the distance is at least one of a Bhattacharyya distance and a symmetric Kullback-Leibler distance.

15. The model generation method according to claim 7, wherein the step of generating one mixture component by using each nearest mixture component sequence uses one of the following information:
variance information of the nearest mixture component sequence;
variance information and mean information of the nearest mixture component sequence; and
variance information, mean information and mixture weight information of the nearest mixture component sequence.

16. A pattern recognition method, comprising the following steps:
a feature extraction step for extracting features by using test data; and
a pattern recognition step for performing pattern recognition on the extracted features by using the first model generated by the model generation method according to claim 1.

17. A model generation device for pattern recognition, comprising:
a mixture-level variance sharing unit for generating a mixture-level variance sharing structure of a first model by using a second model; and
a first model generation unit for generating the first model with the variance sharing structure by using training data of the first model,
wherein in the variance sharing structure, mixture components in respective states have the same shared variances in the same order.

18. The model generation device according to claim 17, wherein the mixture-level variance sharing unit further comprises the following units:
a variance sharing rule design unit for designing a variance sharing rule by using the second model, the variance sharing rule specifying mixture components to be sharing variances among respective states;
a shared variance generation unit for generating shared variances based on the variance sharing rule;
a mixture component reordering unit for reordering mixture components in each state of the second model based on the generated shared variances so that the shared variances of the mixture components in respective states of the second model are in the same order; and
a shared variance copying rule design unit for designing a shared variance copying rule to generate the variance sharing structure by using the shared variances of the reordered mixture components.

19. The model generation device according to claim 18, wherein the variance sharing rule design unit further comprises the following units:
a unit for selecting one reference state from the second model; and
a unit for selecting a mixture component from the selected reference state one by one as a reference mixture component, and generating a nearest mixture component sequence for each selected reference mixture component, until all mixture components in the selected reference state have been selected,
wherein respective mixture components in each nearest mixture component sequence are from respective states of the second model respectively, have the nearest distances among each others, and will have a shared variance.

20. The model generation device according to claim 19, wherein the unit of generating a nearest mixture component sequence for each selected reference mixture component further comprises the following unit:
for the selected reference mixture component, a unit for selecting, from remaining states of the second model other than the selected reference state, a remaining state one by one, and obtaining one nearest mixture component for each selected remaining state, until all remaining states have been selected.

21. The model generation device according to claim 20, wherein the unit of obtaining one nearest mixture component for each selected remaining state further comprises the following units:
a unit for generating, for the selected remaining state, one mixture component based on at least a mixture component related to the selected reference mixture component, the at least mixture component related to the selected reference mixture component comprising the selected reference mixture component and all current nearest mixture components thereof;
a unit for selecting a mixture component from the selected remaining state one by one, and measuring, for each selected mixture component, the distance between it and the generated one mixture component, until all mixture components in the selected remaining state have been selected; and
a unit for comparing the measured distances and obtaining the mixture component with the smallest distance as the nearest mixture component.

22. The model generation device according to claim 20, wherein the variance sharing rule design unit employs a constrained push-pop method,
the variance sharing rule design unit further comprises a unit for initializing a push array and a pop array before selecting one reference state from the second model, the push array and the pop array being used for recording selected mixture components and unselected mixture components in each state of the second model respectively, the initialized push array being empty, and all mixture components in all states of the second model being recorded in the initialized pop array;
the unit of generating a nearest mixture component sequence for each selected reference mixture component further comprises a unit for moving the selected reference mixture component from the pop array to the push array before selecting, from remaining states of the second model other than the selected reference state, a remaining state one by one; and
the unit of generating a nearest mixture component sequence for each selected reference mixture component further comprises a unit for moving the obtained one nearest mixture component from the pop array to the push array after obtaining the one nearest mixture component for each selected remaining state.

23. The model generation device according to claim 19, wherein the shared variance generation unit further comprises the following units:
a unit for obtaining respective nearest mixture component sequences;
a unit for generating one mixture component by using each nearest mixture component sequence; and
a unit for obtaining one shared variance by using the variance of each generated mixture component.

24. The model generation device according to claim 23, wherein the unit of generating one mixture component by using each nearest mixture component sequence further comprises the following unit:
a unit for generating the one mixture component by merging respective mixture components in each nearest mixture component sequence; or
a unit for generating the one mixture component by obtaining a representative mixture component in each nearest mixture component sequence.

25. The model generation device according to claim 18, wherein the mixture component reordering unit reorders the mixture components in each state of the second model based on the order of the generated shared variances.

26. The model generation device according to claim 18, wherein the shared variance copying rule design unit further comprises the following units:
a unit for obtaining a starting position of the shared variances of the reordered mixture components; and
a unit for repeatedly copying the shared variances of the reordered mixture components one by one to respective mixture components in each state of the first model, until all mixture components in each state of the first model have copied shared variances.

27. The model generation device according to claim 17,
wherein the second model is generated off-line by using training data of the second model;
the mixture-level variance sharing unit generates the mixture-level variance sharing structure of the first model off-line; and
the first model generation unit generates the first model with the variance sharing structure on-line.

28. The model generation device according to claim 17, wherein the second model is at least one of a universal background model and a background model.

29. The model generation device according to claim 28, wherein the second model is a Hidden Markov Model or a Gaussian Mixture Model.

30. The model generation device according to claim 19, wherein the distance is at least one of a Bhattacharyya distance and a symmetric Kullback-Leibler distance.

31. The model generation device according to claim 23, wherein the unit of generating one mixture component by using each nearest mixture component sequence uses one of the following information:
variance information of the nearest mixture component sequence;
variance information and mean information of the nearest mixture component sequence; and
variance information, mean information and mixture weight information of the nearest mixture component sequence.

32. A pattern recognition apparatus, comprising the following devices:
a feature extraction device for extracting features by using test data; and
a pattern recognition device for performing pattern recognition on the extracted features by using the first model generated by the model generation device according to claim 17.
